(19) United States
(12) Patent Application Publication
(10) Pub. No.: US 2025/0007074 A1
(43) Pub. Date: Jan. 2, 2025

(54) CONDUCTIVE JOINT BETWEEN SHIELDED COMPOSITES AND METAL PARTS

(71) Applicant: Atieva, Inc., Newark, CA (US)

(72) Inventors: Adam Thipphavong, San Jose, CA (US); Mark Schlocker, Menlo Park, CA (US); Alexander Wibbing, San Francisco, CA (US); Reinhold Stammel, Augsburg (DE)

(21) Appl. No.: 18/704,367

(22) PCT Filed: Oct. 28, 2022
(86) PCT No.: PCT/US2022/078870

§ 371 Date: Apr. 24, 2024

Related U.S. Application Data
(60) Provisional application No. 63/263,170, filed on Oct. 28, 2021.

(51) Int. Cl. H01M 50/264; H01M 50/249

(52) U.S. Cl. CPC H01M 50/264; H01M 50/249

(57) ABSTRACT

A battery pack may include a plurality of batteries and an enclosure surrounding the plurality of batteries. The enclosure includes: a first metal wall member, a second wall member, the second wall member including a fiber-reinforced plastic laminate and having a metal mesh layer within the fiber-reinforced plastic laminate. The battery pack may include a joint between the first metal wall member and the second wall member, wherein the joint includes: an electrically conductive metal fastener that mechanically couples the first metal wall member to the second wall member, and an electrically conductive coupling member in mechanical and electrical contact with the first metal wall member and with the metal mesh layer.

### CROSS-REFERENCE TO RELATED APPLICATION

This application claims priority to U.S. Provisional Patent Application No. 63/263,170, filed on Oct. 28, 2021, and entitled “CONDUCTIVE JOINT BETWEEN SHIELDED COMPOSITES AND METAL PARTS,” the disclosure of which is incorporated by reference herein in its entirety.

### TECHNICAL FIELD

This disclosure relates to a Faraday cage and, in particular, to a conductive joint between shielded composites and metal parts.

### BACKGROUND

In recent years, the world's transportation has begun a transition away from powertrains primarily driven by fossil fuels and toward more sustainable energy sources, chiefly among them electric motors powered by on-board energy storages. In order to make these new modes of transportation available to larger segments of population, vehicle makers are striving to reduce the weight of components used in such electric motors and to increase the safety of such components.

### SUMMARY

In some aspects, a battery pack includes: a plurality of batteries and an enclosure surrounding the plurality of batteries. The enclosure includes a first metal wall member, a second wall member, where the second wall member includes a fiber-reinforced plastic laminate and having a metal mesh layer within the fiber-reinforced plastic laminate. The enclosure includes and a joint between the first metal wall member and the second wall member, where the joint includes: an electrically conductive metal fastener that mechanically couples the first metal wall member to the second wall member; and an electrically conductive coupling member in mechanical and electrical contact with the first metal wall member and with the metal mesh layer.

Implementations can include one or more of the following features, alone or in any combination with each other.

For example, the second wall member can include a through hole through which the electrically conductive metal fastener passes to mechanically couple the first metal wall to the second wall member, and the electrically conductive coupling member can include a conductive cylinder within the through hole that makes electrical contact with the metal mesh layer and with the first metal wall member.

For example, first metal wall member, the metal mesh layer, and the joint can form a Faraday cage around the plurality of batteries.

For example, the conductive cylinder within the through hole can make electrical contact with the metal mesh layer and with the electrically conductive metal fastener.

For example, the conductive cylinder can include a vertical slot in the cylinder, such that the diameter of the cylinder can be reduced by applying an inward radial force to outside walls of the cylinder.

For example, a relaxed outer diameter of the cylinder can be greater than an inner diameter of the through hole of the second wall member.

For example, the conductive cylinder can include a compression limiter.

For example, a length of the conductive cylinder can be greater than a thickness of the second wall member.

For example, the electrically conductive metal fastener can include a head having a diameter greater than a diameter of the through hole and having a shaft having a diameter smaller than a diameter of the through hole, the head capturing portions the second wall member around the through hole against the first metal wall member.

For example, the mesh layer can include steel or copper.

In some aspects, the techniques described herein relate to an enclosure including a first metal wall member, a second wall member, the second wall member including a fiber-reinforced plastic laminate and having a metal mesh layer within the fiber-reinforced plastic laminate, and a joint between the first metal wall member and the second wall member. The joint includes an electrically conductive metal fastener that mechanically couples the first metal wall member to the second wall member and an electrically conductive coupling member in mechanical and electrical contact with the first metal wall member and with the metal mesh layer. The second wall member includes a through hole through which the electrically conductive metal fastener passes to mechanically couple the first metal wall to the second wall member, and wherein the electrically conductive coupling member includes a conductive cylinder within the through hole that makes electrical contact with the metal mesh layer and with the first metal wall member.

Implementations can include one or more of the following features, alone or in any combination with each other.

For example, the second wall member can include a through hole through which the electrically conductive metal fastener passes to mechanically couple the first metal wall to the second wall member, and the electrically conductive coupling member can include a conductive cylinder within the through hole that makes electrical contact with the metal mesh layer and with the first metal wall member.

For example, first metal wall member, the metal mesh layer, and the joint can form a Faraday cage around the plurality of batteries.

For example, the conductive cylinder within the through hole can make electrical contact with the metal mesh layer and with the electrically conductive metal fastener.

For example, the conductive cylinder can include a vertical slot in the cylinder, such that the diameter of the cylinder can be reduced by applying an inward radial force to outside walls of the cylinder.

For example, a relaxed outer diameter of the cylinder can be greater than an inner diameter of the through hole of the second wall member.

For example, the conductive cylinder can include a compression limiter.

For example, a length of the conductive cylinder can be greater than a thickness of the second wall member.

For example, the electrically conductive metal fastener can include a head having a diameter greater than a diameter of the through hole and having a shaft having a diameter smaller than a diameter of the through hole, the head capturing portions the second wall member around the through hole against the first metal wall member.

For example, the mesh layer can include steel or copper.

### BRIEF DESCRIPTION OF DRAWINGS

FIG. 1 shows an example of a vehicle.

FIG. 2 provides a perspective view of a battery pack configured to be mounted under vehicle chassis.

FIG. 3 is a cross-sectional view of the battery pack through line A-A′ in FIG. 2.

FIG. 4 is a schematic cross-sectional view of a connection or joint between the metal frame and the base plate.

FIGS. 5A, 5B, and 5C, respectively, are schematic diagrams of an end view, a cross sectional view, and a perspective view of an example compression limiter that can be inserted into a through hole of a base plate to provide an electrical connection between a metal mesh layer of the base plate and a metal frame.

### DETAILED DESCRIPTION

Examples herein refer to a battery module, which is an individual component configured for holding and managing multiple electrochemical cells during charging, storage, and use. The battery module can be intended as the sole power source for one or more loads (e.g., electric motors), or more than one battery module of the same or different type can be used. Two or more battery modules can be implemented in a system separately or as part of a larger energy storage unit. For example, a battery pack can include two or more battery modules of the same or different type. A battery module can include control circuitry for managing the charging, storage, and/or use of electrical energy in the electrochemical cells, or the battery module can be controlled by an external component. For example, a battery management system can be implemented on one or more circuit boards (e.g., a printed circuit board).

Examples herein refer to electrochemical cells. An electrochemical cell can include an electrolyte and two electrodes to store energy and deliver it when used. In some implementations, the electrochemical cell can be a rechargeable cell. For example, the electrochemical cell can be a lithium-ion cell. In some implementations, the electrochemical cell can act as a galvanic cell when being discharged, and as an electrolytic cell when being charged. The electrochemical cell can have at least one terminal for each of the electrodes. The terminals, or at least a portion thereof, can be positioned at one end of the electrolytic cell. For example, when the electrochemical cell has a cylindrical shape, one of the terminals can be provided in the center of the end of the cell, and the can that forms the cylinder can constitute the other terminal and therefore be present at the end as well. Other shapes of electrochemical cells can be used, including, but not limited to, prismatic shapes.

Examples described herein refer to a vehicle. As used herein, a vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. A vehicle can be powered by one or more types of power sources. In some implementations, a vehicle is powered solely by electricity, or can use one or more other energy sources in addition to electricity, to name just a few examples.

As used herein, the terms “electric vehicle” and “EV” may be used interchangeably and may refer to an all-electric vehicle, a plug-in hybrid vehicle, also referred to as a PHEV, or a hybrid vehicle, also referred to as a HEV, where a hybrid vehicle utilizes multiple sources of propulsion including an electric drive system.

Examples herein refer to a vehicle chassis. A vehicle chassis is a framework that bears the load of the rest of the vehicle. A vehicle chassis can include one or more frames, which can be made of steel, aluminum alloy, or another stiff and strong material. For example, a vehicle chassis is sometimes made of at least two side rails connected by multiple cross members for structural integrity. One or more other components, including, but not limited to, a battery pack for an electric or hybrid vehicle, can be integrated into or otherwise combined with a vehicle chassis. A subframe is a chassis portion that can carry certain components, including but not limited to, a motor, drivetrain, or suspension, to spread chassis loads and/or isolate vibrations and harshness.

Examples herein refer to a vehicle body. A vehicle body is the main supporting structure of a vehicle to which components and subcomponents are attached. In vehicles having unibody construction, the vehicle body and the vehicle chassis are integrated into each other. As used herein, a vehicle chassis is described as supporting the vehicle body also when the vehicle body is an integral part of the vehicle chassis. The vehicle body often includes a passenger compartment with room for one or more occupants; one or more trunks or other storage compartments for cargo; and various panels and other closures providing protective and/or decorative cover.

In the following text, the terms “battery”, “cell”, and “battery cell” may be used interchangeably and may refer to any of a variety of different battery configurations and chemistries. Typical battery chemistries include, but are not limited to, lithium ion, lithium ion polymer, nickel metal hydride, nickel cadmium, nickel hydrogen, nickel zinc, and silver zinc. The terms “battery pack” and “battery pack enclosure” may be used interchangeably and refer to an enclosure containing one or more batteries electrically interconnected to achieve the desired voltage and capacity. The term “electric vehicle” as used herein may refer to an all-electric vehicle, also referred to as an EV, a plug-in hybrid vehicle, also referred to as a PHEV, or a hybrid vehicle, also referred to as a HEV, where a hybrid vehicle utilizes multiple sources of propulsion including an electric drive system.

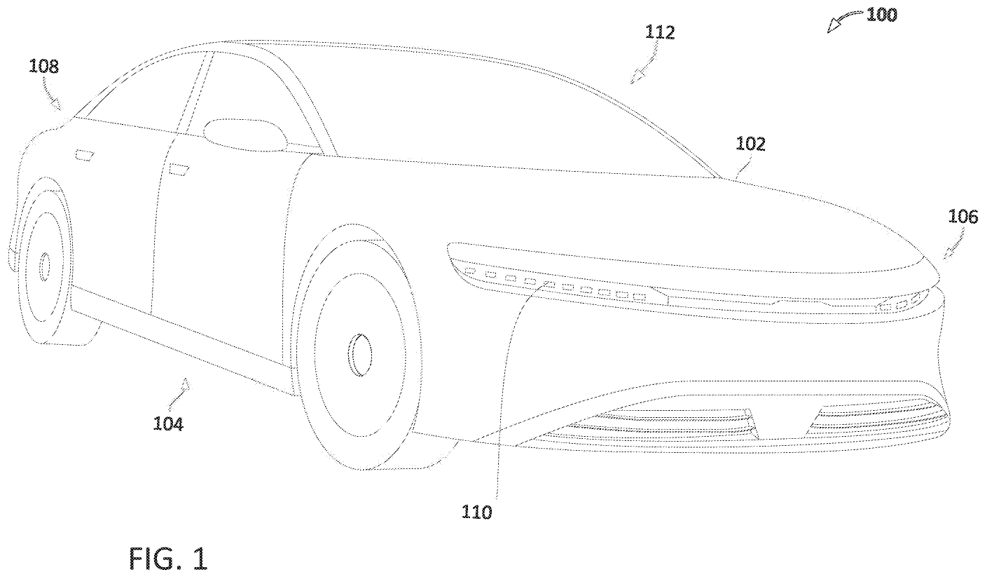

FIG. 1 shows an example of a vehicle 100. The vehicle 100 can be used with one or more other examples described elsewhere herein. The vehicle 100 includes a vehicle body 102 and a vehicle chassis 104 supporting the vehicle body 102. For example, the vehicle body 102 is here of a four-door type with room for at least four occupants, and the vehicle chassis 104 has four wheels. Other numbers of doors, types of vehicle body 102, and/or kinds of vehicle chassis 104 can be used in some implementations.

The vehicle body 102 has a front 106 and a rear 108 and can have a passenger cabin 112 between the front and the rear. The vehicle 100 can have at least one motor, which can be positioned in one or more locations of the vehicle 100. In some implementations, the motor(s) can be mounted generally near the front 106, generally near the rear 108, or both. A battery module can be supported by chassis 104, for example, below the passenger cabin and can be used to power the motor(s). The vehicle 100 can have at least one lighting component, which can be situated in one or more locations of the vehicle 100. For example, the vehicle 100 can have one or more headlights 110 mounted generally near the front 106.

The rear 108 of the vehicle 100 can include a trunk compartment, and the front 106 of the vehicle 100 can include a front trunk (a.k.a., frunk) compartment, each of which is outside the passenger cabin and each of which can be used for storage of vehicle components or personal equipment. For example, one or more electrical circuit modules can be included within the trunk or the frunk can be used to manage the charging of the batteries in the battery module and to manage the distribution of electrical current from the battery module to the one or more motors in the vehicle.

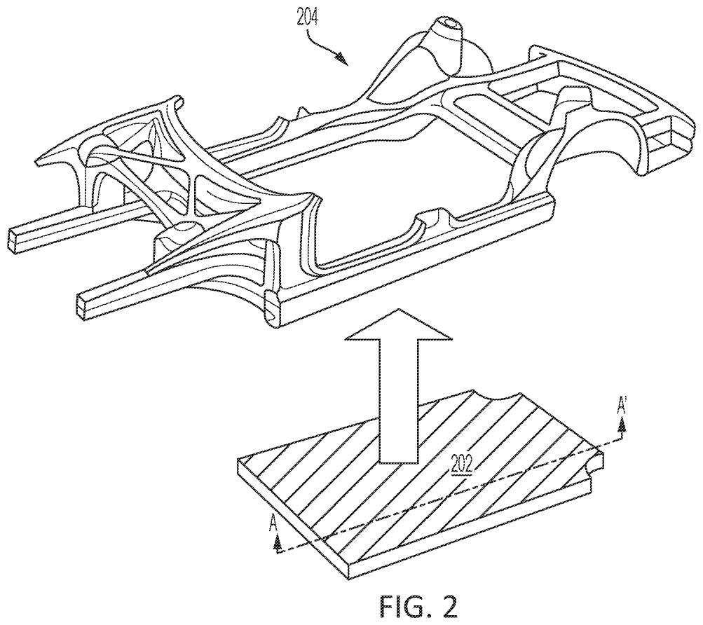

FIG. 2 provides a perspective view of a battery pack 202 configured to be mounted under vehicle chassis 204. It should be understood that the present invention is not limited to a specific battery pack mounting scheme, battery pack size, or battery pack configuration.

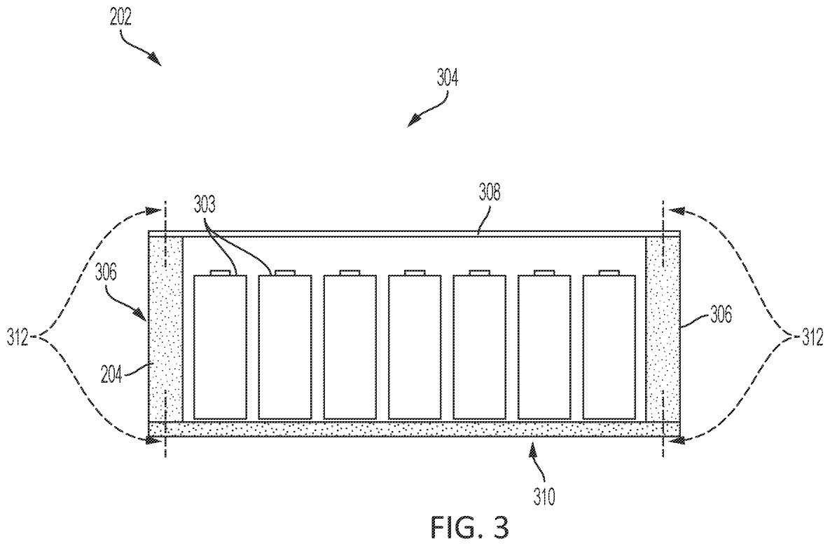

FIG. 3 is a cross-sectional view of the battery pack 202 through line A-A′ in FIG. 2. The battery pack 202 includes a battery enclosure 304 in which a plurality of batteries or battery cells 303 are contained. The battery enclosure 304 includes a frame 306, a cover 308, and a base plate 310 that together form a closed cavity within which the battery cells 303 are contained. Thus, the frame 306, the cover 308, and the base plate 310 can define, respectively, a first, second, and third wall member of the enclosure 304. In some implementations, the frame 306 and the cover 308 can include electrically conductive materials (e.g., aluminum or steel). The electrically conductive materials of the frame 306 and/or the cover 308 can be provided in the form of one or more continuous metal sheets or solid wall members. In some implementations, the base plate 310 can be made of non-conductive materials, for example, a fiber-reinforced plastic (FRP) material, such as, for example, a fiberglass laminate or a carbon fiber laminate. The use of FRP in the base plate 310 can reduce the overall weight of the enclosure 304 and also can provide a strong protective bottom wall for the enclosure, which protects the battery cells 303 in the enclosure from damage.

To ensure isolation of the batteries 303 from electromagnetic interference (EMI) created by other electrical components within the vehicle, the battery enclosure 304 can form a Faraday cage around the batteries 303. To create an effective Faraday cage with the battery enclosure 304 around the batteries 303, a layer of electrically conductive materials can be included in the laminate of the base plate 310. For example, the fiber reinforced plastic laminate of the base plate 310 can include a metal mesh layer, for example, a steel mesh layer or a copper mesh layer. Furthermore, to create an effective Faraday cage, electrically conductive connections between the cover 308 and the metal frame 306 and between the metal frame 306 and the metal mesh layer within the base plate 310 are provided.

In some implementations, an electrically conductive connection between the cover 308 and the metal frame 306 can be provided, for example, by welding or soldering the cover to the metal frame. In some implementations, an electrically conductive connection between the cover 308 and the metal frame 306 can be provided, for example, by fastening the cover and the metal frame with electrically conductive fasteners 312, for example, metal bolts or machine screws.

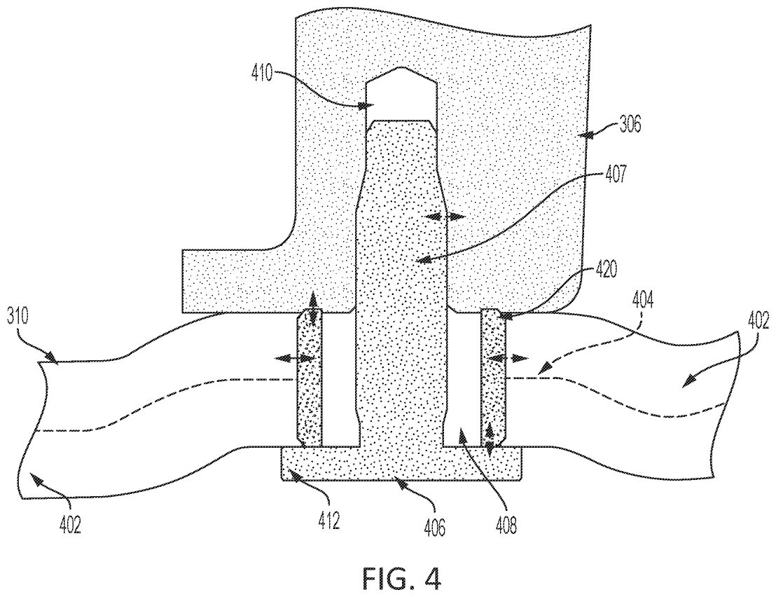

FIG. 4 is a schematic cross-sectional view of a connection or joint between the metal frame 306 and the base plate 310. As explained above, the base plate 310 can include a laminate of nonconductive materials and a metal mesh layer 404, so that the metal mesh layer can complete the Faraday cage with the metal frame 306 and the cover 308 (FIG. 3). The base plate 310 can be fastened to the metal frame 306 by an electrically conductive fastener 406. For example, the fastener 406 can be a metal (e.g., galvanized steel, stainless steel, or steel with a corrosion-resistant (e.g., ZnNi) coating. The shaft 407 of the fastener 406 can pass through a through hole 408 in the base plate 310 and into a blind hole 410 of the metal frame 306. For example, threads on the shaft 407 of the fastener 406 can thread into tapped threads of the blind hole 410 of the metal frame 306. A head 412 of the fastener 406, which can have a diameter larger than the diameter of the through hole 408, can press the base plate 310 against the metal frame 306 when the threads of the shaft 407 of the fastener 406 pull the fastener into the blind hole 410.

In some implementations, an electrically conductive coupling cylinder 420 can fit within the through hole 408 and make an electrical connection with the metal mesh layer 404 that is exposed to the through hole. In addition, the conductive coupling cylinder 420 can make an electrical connection with the head 412 of the fastener 406 and with the metal frame 306. Thus, the conductive coupling cylinder 420 provides one or more electrically conductive pathways between the metal mesh layer 404 of the base plate 310 to the metal frame 306. One pathway can be from the metal mesh layer 404, through the conductive coupling cylinder 420, and to the metal frame 306 from the conductive coupling cylinder 420. Another pathway can be from the metal mesh layer 404, through the conductive coupling cylinder 420, through the head 412 and the shaft 407 of the fastener 406, and to the metal frame 306 from the shaft 407.

The conductive coupling cylinder 420 can function as, or can be considered to be, a compression limiter that limits the compressive forces on the base plate 310 when the fastener 406 is fastened to the metal frame 306. The conductive coupling cylinder 420 can be made of a stable, high-modulus material (e.g., steel, brass, etc.) and can include a vertical slot in a wall of the coupling cylinder, so that the coupling cylinder can be squeezed by a force in the radial direction to reduce its diameter from a relaxed diameter while it is inserted into the through hole 408. The relaxed outer diameter of the coupling cylinder 420, which is the outer diameter of the cylinder 420 when no forces are applied to it, can be larger than an inner diameter of the through hole 408. Thus, when the radial force is removed from the coupling cylinder, the diameter of the coupling cylinder can expand, such that it fits tightly into the through hole and makes a secure mechanical and electrical connection with the metal mesh layer 404 within the base plate 310.

If the composite material of the base plate 310 has a tendency to “creep” or to deform over time (e.g., to reduce its thickness between the head 412 of the fastener 416 and the metal frame 306) due to the compressive force between the head and the frame, the compression limiting coupling cylinder 420 can bear the load of the compressive force, such that the composite material does not deform and a force between the head and the coupling cylinder is maintained and a torque between the threads of the shaft 407 and the threads of the blind hole 410 is maintained over time. For example, in some implementations a length of the coupling cylinder 420 can be greater than the thickness of the base plate 310, so that when the fastener is tightened into position the base plate 310 excessive compressive forces are not applied to the base plate 310.

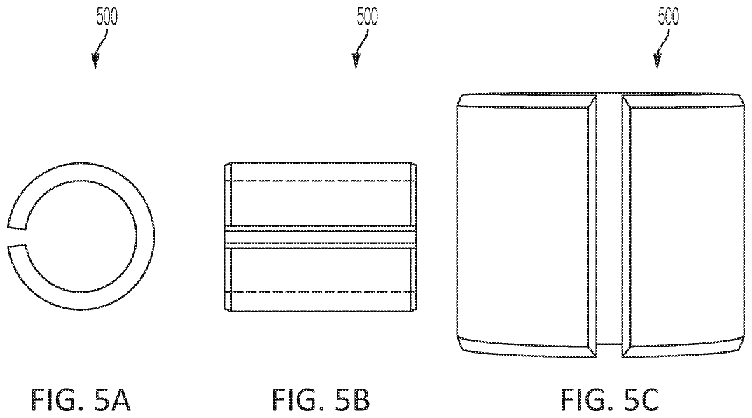

FIGS. 5A, 5B, and 5C, respectively, are schematic diagrams of an end view, a cross sectional view, and a perspective view of an example compression limiter 500 that can be inserted into the through hole 408 of the base plate 310 to provide an electrical connection between the metal mesh layer 404 of the base plate 310 and the metal frame 306. The compression limiter 500 can be of a cylindrical ring shape with a vertical slot in an azimuthal section of the cylinder. Thus, the compression limiter 500 can have a diameter that is larger than the diameter of the through hole 408, but can be squeezed to close or reduce the size of the slot, and thereby to reduce the diameter of the compression limiter, so that it can be placed into the through hole, where it can then expand to provide a good mechanical and electrical contact between the metal mesh layer 404 and the compression limiter.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of subject matter appearing in this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems.

While certain features of the described implementations have been illustrated as described herein, many modifications, substitutions, changes and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore, the disclosures and descriptions herein are intended to be illustrative, but not limiting, of the scope of the invention.

1. A battery pack comprising:
a plurality of batteries; and
an enclosure surrounding the plurality of batteries, wherein the enclosure includes:
a first metal wall member,
a second wall member, the second wall member including a fiber-reinforced plastic laminate and having a metal mesh layer within the fiber-reinforced plastic laminate; and
a joint between the first metal wall member and the second wall member, wherein the joint includes:
an electrically conductive metal fastener that mechanically couples the first metal wall member to the second wall member; and an electrically conductive coupling member in mechanical and electrical contact with the first metal wall member and with the metal mesh layer.

2. The battery pack of claim 1,
wherein the second wall member includes a through hole through which the electrically conductive metal fastener passes to mechanically couple the first metal wall to the second wall member, and
wherein the electrically conductive coupling member includes a conductive cylinder within the through hole that makes electrical contact with the metal mesh layer and with the first metal wall member.

3. The battery pack of claim 2, wherein first metal wall member, the metal mesh layer, and the joint form a Faraday cage around the plurality of batteries.

4. The battery pack of claim 2, wherein the conductive cylinder within the through hole makes electrical contact with the metal mesh layer and with the electrically conductive metal fastener.

5. The battery pack of claim 2, wherein the conductive cylinder includes a vertical slot in the cylinder, such that a diameter of the cylinder can be reduced by applying an inward radial force to outside walls of the cylinder.

6. The battery pack of claim 5, where a relaxed outer diameter of the cylinder is greater than an inner diameter of the through hole of the second wall member.

7. The battery pack of claim 2, wherein the conductive cylinder includes a compression limiter.

8. The battery pack of claim 7, wherein a length of the conductive cylinder is greater than a thickness of the second wall member.

9. The battery pack of claim 2, wherein the electrically conductive metal fastener includes a head having a diameter greater than a diameter of the through hole and having a shaft having a diameter smaller than a diameter of the through hole, the head capturing portions of the second wall member around the through hole against the first metal wall member.

10. The battery pack of claim 2, wherein the mesh layer includes steel or copper.

11. An enclosure comprising:
a first metal wall member;
a second wall member, the second wall member including a fiber-reinforced plastic laminate and having a metal mesh layer within the fiber-reinforced plastic laminate; and
a joint between the first metal wall member and the second wall member, wherein the joint includes:
an electrically conductive metal fastener that mechanically couples the first metal wall member to the second wall member; and
an electrically conductive coupling member in mechanical and electrical contact with the first metal wall member and with the metal mesh layer,
wherein the second wall member includes a through hole through which the electrically conductive metal fastener passes to mechanically couple the first metal wall to the second wall member, and
wherein the electrically conductive coupling member includes a conductive cylinder within the through hole that makes electrical contact with the metal mesh layer and with the first metal wall member.

12. The enclosure of claim 11, wherein first metal wall member, the metal mesh layer, and the joint form a Faraday cage.

13. The enclosure of claim 12, wherein the conductive cylinder within the through hole makes electrical contact with the metal mesh layer and with the electrically conductive metal fastener.

14. The enclosure of claim 11, wherein the conductive cylinder includes a vertical slot in the cylinder, such that a diameter of the cylinder can be reduced by applying an inward radial force to outside walls of the cylinder.

15. The enclosure of claim 14, where a relaxed outer diameter of the cylinder is greater than an inner diameter of the through hole of the second wall member.

16. The enclosure of claim 11, wherein the conductive cylinder includes a compression limiter.

17. The enclosure of claim 16, wherein a length of the conductive cylinder is greater than a thickness of the second wall member.

18. The enclosure of claim 11, wherein the electrically conductive metal fastener includes a head having a diameter greater than a diameter of the through hole and having a shaft having a diameter smaller than a diameter of the through hole, the head capturing portions of the second wall member around the through hole against the first metal wall member.

19. The enclosure of claim 11, wherein the mesh layer includes steel or copper.
